(19) United States
(12) Patent Application Publication
(10) Pub. No.: US 2016/0231595 A1
(43) Pub. Date: Aug. 11, 2016

(54) LENS FOR SUNGLASSES

(71) Applicant: LUXOTTICA S.R.L., Agordo (IT)

(72) Inventor: Omar GRASSO, Chivasso (IT)

(21) Appl. No.: 15/024,770

(22) PCT Filed: Sep. 16, 2014
(86) PCT No.: PCT/EP2014/069715

§ 371 Date: Mar. 24, 2016

(30) Foreign Application Priority Data
Sep. 25, 2013 (IT) BO2013A000525

(51) Int. Cl. G02C 7/10; G02B 1/14; G02C 7/12

(52) U.S. Cl. CPC G02C 7/102; G02C 7/12; G02C 7/108; G02B 1/14; G02C 2202/16

(57) ABSTRACT

A lens for sunglasses includes a convex front surface, functionally directed toward an item to be viewed, and a concave rear surface, functionally directed toward the eye of a person who is wearing the eyeglasses. The lens further includes a photochromatic layer, proximate to the front surface, and a screening layer defining a UV filter, proximate to the rear surface and arranged between the rear surface and the photochromatic layer. The photochromatic layer is in the range of wavelengths comprised between 380 nm and 780 nm and has a transmittance comprised between 10% and 60%, in an activated state thereof, and a wavelength comprised between 80% and 95%, in a deactivated state thereof. The screening layer has a transmittance lower than 0.5% in the range of wavelengths comprised between 280 nm and 400 nm.

### TECHNICAL FIELD

The present disclosure relates to a lens for sunglasses.

### BACKGROUND

In lenses for eyeglasses, the use is known of photochromatic elements, which provide an effect that screens the sun rays and which is activated or deactivated as a function of the radiation received by the lens proper.

Furthermore, the use is known of elements that screen the sun rays in a preset range of wavelengths, in which the screening effect is independent of the radiation, i.e. it is always active.

Also known, for example from U.S. Pat. No. 5,135,298, WO2010111499, or WO2008110045, are technical solutions which involve combining, in a multilayer lens, photochromatic elements and permanent filters that are configured to block the blue or UV component of the sun rays.

The combination of such components has undoubted advantages but, in and of itself, it does not offer a guarantee of particularly effective protection in all lighting conditions and in the entire spectrum of UV and visible frequencies.

### SUMMARY

The aim of the present disclosure is to provide a lens for eyeglasses which overcomes the drawbacks of conventional lenses as described above.

In particular, the present disclosure provides a lens for eyeglasses which is capable of ensuring a good level of protection in all lighting conditions.

The present disclosure also provides a lens for eyeglasses that allows freedom of choice in the tint of the lens, in order to confer a pleasant aesthetic appearance to someone who sees the lens of eyeglasses worn by another person.

The lens has a front surface, functionally directed toward an item to be viewed, and a rear surface, functionally directed toward the eye of a person who is wearing the eyeglasses.

In particular, the lens of the disclosure is a multilayer lens.

The lens comprises a photochromatic layer and (at least) one screening layer that defines a UV filter (specifically a UV400 filter).

The photochromatic layer is arranged in front of (or at least not behind) the screening layer (UV400); i.e., the screening layer is arranged at a distance from the front surface that is greater than or equal to the distance of the photochromatic layer from the front surface.

This makes it possible to prevent the screening layer from having an inhibiting effect on the activation of the photochromatic layer.

Preferably, the photochromatic layer is proximate to the front surface, while the screening layer is proximate to the rear surface, such that the screening layer is arranged between the rear surface and the photochromatic layer.

Alternatively, the screening layer and the photochromatic layer may be arranged at the same distance from the front surface of the lens; in this case, for example, the lens will comprise a layer (a film, a coating or a wafer) made of a material that comprises a substance that has UV400 filtering properties and a substance that has photochromatic properties, mixed together. In such case, the photochromatic and screening layers are interpenetrated in a single layer.

Such substances are constituted, for example, by powders, or by liquid solutions.

According to the disclosure, the photochromatic layer, in the range of wavelengths comprised between 380 nm and 780 nm, has a transmittance comprised between 10% and 60%, in an activated state thereof and a wavelength comprised between 80% and 95%, in a deactivated state thereof

Furthermore, the screening layer has a transmittance lower than 0.5% (preferably lower than 0.1%) in the range of wavelengths comprised between 280 nm and 400 nm.

It should be noted that, in the present description, a UV transmittance of between 280 nm and 400 nm means the TSUV transmittance of 280-400 calculated according to the AS/NZS 1067:2003.

The lens can be made of glass, or of plastics or resin; furthermore, it is also possible for the lens to have a multilayer structure that comprises (at least) one element made of glass and (at least) one element made of plastics or resin.

In a possible embodiment, the lens comprises two wafers which are superimposed and bonded by way of one or more layers of adhesive; the rear wafer has a convex surface thereof connected to a concave surface of the front layer.

In such case, the photochromatic layer can be defined by the front wafer or by the layer of adhesive.

The screening layer (UV400) can be defined by the rear wafer or, if the photochromatic layer is defined by the front wafer, by the adhesive. The fact that the screening layer (UV400) is in the adhesive has the advantage of rendering the lens particularly economical to make, because it introduces the possibility of using a rear wafer without an UV400 filter.

It is also possible to interpose a polarizing film between the two wafers; in this case the lens comprises two layers of adhesive, between which the polarizing film is interposed.

The rear wafer can also be tinted. In such case, people who see the eyeglasses externally, when they are worn by another person, see the lenses tinted with such color.

In such embodiment of the structure of the lens, the two wafers can both be made of glass; alternatively, the two wafers can both be made of plastics or resin; alternatively, the front wafer can be made of plastics and the rear wafer can be made of glass, or vice versa.

According to another embodiment (of the structure of the lens), the lens can comprise a photochromatic wafer, on which an element is overmolded which defines the screening layer (with UV400 protection). The overmolded mass, preferably, is tinted.

According to a further variation of embodiment of the lens made of plastics or resin, the lens can have a body that defines the screening layer (with UV400 protection), on whose front surface a photochromatic coating is present. In such case, preferably, the photochromatic coating is protected by a scratch-resistant lacquer. The body of the lens, preferably, is tinted.

It should be noted that the present disclosure also makes available eyeglasses with a frame and at least one lens.

Preferably, the photochromatic layer, or another (any other) layer of the lens is made of a tinted (permanently tinted) material; this gives the lens at least two different tints, with consequent change of tint of the lens (as a function of the change of state of the photochromatic layer, activated or deactivated); this gives the lens a particular aesthetic value. In fact, when the photochromatic layer is in the deactivated state, the tint of the lens for an external observer is the one conferred by the tinted element (for example yellow). When the photochromatic layer is in the activated state, by the very fact of being activated, it will give a tint to the lens (for example blue in the absence of the tinted material). Therefore, the tint assumed by the lens when the photochromatic layer is activated (green in the example given above) is constituted by the chromatic combination of the (“base”) tint of the tinted element and of the tint that the photochromatic layer would assume in the absence of the tinted element.

In other words, the change in tint is due to the fact that one part of the lens is already tinted (for example a wafer, or an overmolded layer); when the photochromatic layer is activated, the second tint is seen, which is due to the sum (i.e. chromatic combination) of the base tint and the tint of the photochromatic layer in its activated state.

### BRIEF DESCRIPTION OF THE DRAWINGS

This and other characteristics will become better apparent from the following description of preferred embodiments, which is illustrated merely for the purposes of non-limiting example:

FIG. 1 is an exploded schematic view of the lens of the disclosure, according to a first embodiment;

FIG. 2 is a schematic view of the lens of the disclosure, in a second embodiment; and

FIG. 3 is a schematic view of the lens of the disclosure, in a third embodiment.

### DETAILED DESCRIPTION OF THE DRAWINGS

In the figures, the reference numeral 1 generally designates a lens for sunglasses.

The lens 1 has a (convex) front surface 2, functionally directed toward an item to be viewed, and a (concave) rear surface 3, functionally directed toward the eye of a person who is wearing the eyeglasses.

The lens comprises a photochromatic layer, proximate to the front surface 2, and a screening layer that defines a UV filter, proximate to the rear surface 3, and is thus arranged between the rear surface 3 and the photochromatic layer.

The photochromatic layer, in the range of wavelengths comprised between 380 nm and 780 nm, has a transmittance comprised between 10% and 60%, in an activated state thereof, and a wavelength comprised between 80% and 95%, in a deactivated state thereof

The screening layer has a transmittance lower than 0.5% (preferably lower than 0.1%) in the range of wavelengths comprised between 280 nm and 400 nm.

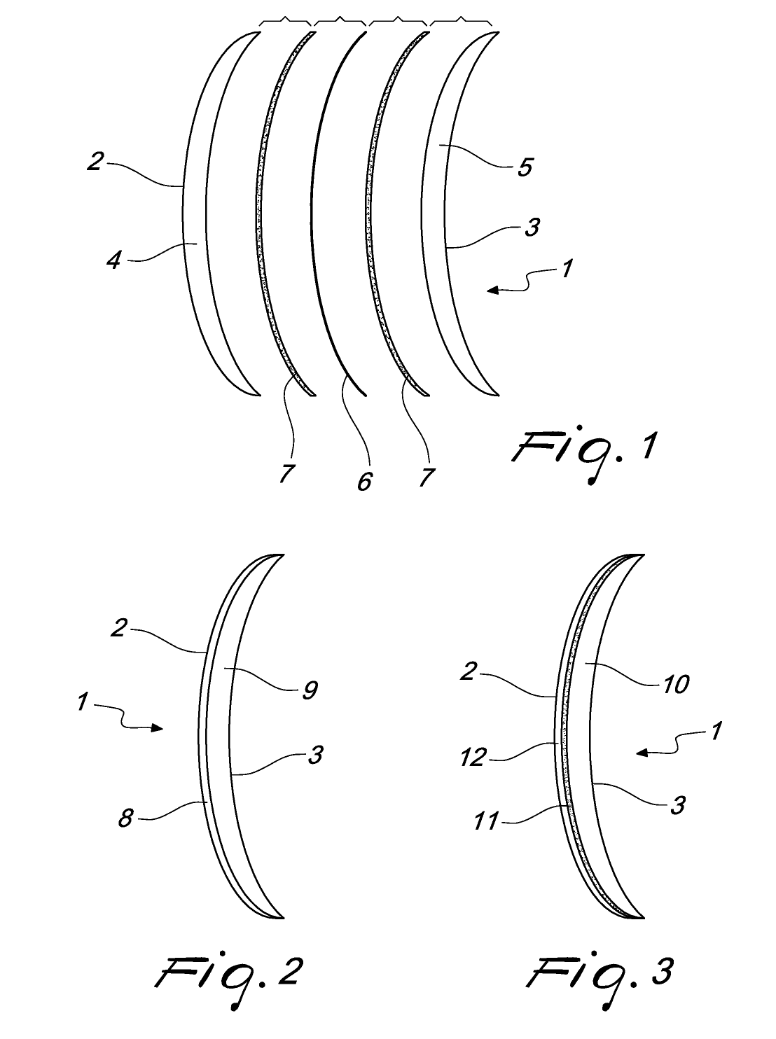

With reference to the embodiment illustrated in FIG. 1, the lens 1 comprises a front wafer 4 and a rear wafer 5.

Preferably, a polarizing film 6 is interposed between the front wafer 4 and the rear wafer 5.

Furthermore, the lens 1 comprises a layer of adhesive 7 interposed between the front wafer 4 and the polarizing film 6 and another layer of adhesive 7 interposed between the polarizing film 6 and the rear wafer 5.

However, the polarizing film 6 can also be absent; in such case there is a single layer 7 of adhesive interposed between the front wafer 4 and the rear wafer 5.

The front wafer 4 and the rear wafer 5 can be made of glass or of plastics or resin.

The photochromatic layer is defined by the front wafer 4 or, alternatively, by the layer 7 of adhesive (or by at least one of the two layers 7 of adhesive, if the polarizing film 6 is present); in particular, in such case, the adhesive 7 has a photochromatic tint or pigment (dissolved within it).

If the front wafer 4 is photochromatic, the screening layer (which defines the UV400 filter) is defined by the rear wafer 5 or, alternatively, by the layer 7 of adhesive.

If the layer 7 of adhesive is photochromatic, the screening layer (which defines the UV400 filter) is defined by the rear wafer 5.

If the polarizing film 6 is present, interposed between the two layers 7 of adhesive, then the layer 7 of adhesive proximate to the front wafer 4 defines the photochromatic layer, and the layer 7 of adhesive proximate to the rear wafer 5 defines the screening layer (which defines the UV400 filter).

Preferably, the rear wafer 5 is tinted.

In such case, if the rear wafer does not define the screening layer, then preferably, the tinted rear wafer 5 has a transmittance comprised between 20% and 70%, in the range of wavelengths comprised between 380 nm and 780 nm.

Preferably, the polarizing film 6 has a transmittance comprised between 20% and 70%, in the range of wavelengths comprised between 380 nm and 780 nm.

With reference to the embodiment shown in FIG. 2, the lens 1 comprises a polychromatic wafer 8, which defines the photochromatic layer; the photochromatic wafer 8 is made of plastics or of resin; alternatively, such wafer 8 can be made of glass.

Furthermore, the lens 1 comprises an element 9 that is overmolded on the wafer 8 on the opposite side from the front surface 2; thus the overmolded element 9 defines the rear surface 3 of the lens 1.

The screening layer is defined by the mass of the overmolded element 9.

Preferably, the mass of the overmolded element is tinted.

Preferably, such tinted overmolded element has a transmittance comprised between 20% and 70%, in the range of wavelengths comprised between 380 nm and 780 nm.

With reference to the embodiment shown in FIG. 3, the lens 1 has a body 10 made of a plastic material or made of a resin that screens UV rays, so as to define such screening layer (which defines the UV400 filter).

Furthermore, the lens 1 comprises a photochromatic coating 11 arranged on the side of the front surface 2 and defining the photochromatic layer.

Preferably, the lens 1 also comprises a scratch-resistant lacquer 12 overlaid on the photochromatic coating 11.

Preferably, the body 10 of the lens 1 is polarizing (or tinted).

The disclosures in Italian Patent Application No. BO2013A000525 from which this application claims priority are incorporated herein by reference.

1-18. (canceled)

19. A lens for sunglasses, which has a convex front surface, functionally directed toward an item to be viewed, and a concave rear surface, functionally directed toward the eye of a person who is wearing the eyeglasses, and which comprises a photochromatic layer and a screening layer that defines a UV filter, wherein the screening layer is arranged at a distance from the front surface that is greater than or equal to the distance of the photochromatic layer from said front surface, wherein:
the photochromatic layer, in the range of wavelengths comprised between 380 nm and 780 nm, has a transmittance comprised between 10% and 60%, in an activated state, and a wavelength comprised between 80% and 95%, in a deactivated state;
the screening layer has a transmittance lower than 0.5% in the range of wavelengths comprised between 280 nm and 400 nm.

20. The lens according to claim 19, wherein the screening layer has a transmittance lower than 0.1% in the range of wavelengths comprised between 280 nm and 400 nm.

21. The lens according to claim 19, further comprising a front wafer, a rear wafer and a layer of adhesive interposed between the front and rear wafers in order to stably bond the front and rear wafers.

22. The lens according to claim 21, wherein:
the front wafer is photochromatic, so as to define said photochromatic layer;
said adhesive defines a UV filter and/or the rear wafer defines a UV filter, so as to define said screening layer.

23. The lens according to claim 21, wherein:
said adhesive has a photochromatic pigment, so as to define said photochromatic layer;
the rear wafer has a UV filter which defines said screening layer.

24. The lens according to claim 21, wherein the rear wafer is tinted.

25. The lens according to claim 21, further comprising a polarizing film, wherein said layer of adhesive is divided into a front film of adhesive, adhering to the front wafer, and a rear film of adhesive, adhering to the rear wafer, the polarizing film being interposed between said front and rear adhesive films.

26. The lens according to claim 21, further comprising a pigmented lacquer applied to a rear face of the front wafer or to a front face of the rear wafer, so as to define the photochromatic layer.

27. The lens according to claim 21, wherein said front and rear wafers are made of glass.

28. The lens according to claim 21, wherein said front and rear wafers are both made of plastics or resin, or one of the front and rear wafers is made of plastics or resin and the other of the front and rear wafers is made of glass.

29. The lens according to claim 19, further comprising:
a photochromatic wafer, which defines said photochromatic layer;
an element overmolded on said photochromatic wafer on an opposite side from the front surface, and defining the rear surface, wherein said screening layer is defined by the mass of the overmolded element.

30. The lens according to claim 29, wherein the mass of the overmolded element is tinted.

31. The lens according to claim 19, wherein the lens has a body made of a plastic material that screens UV rays, so as to define said screening layer, and comprises a photochromatic coating arranged on the side of the front surface and defining the photochromatic layer.

32. The lens according to claim 31, wherein the body of the lens is polarizing.

33. The lens according to claim 31, wherein said photochromatic coating is protected by a scratch-resistant lacquer.

34. The lens according to claim 19, wherein the polarizing and/or tinted element of the lens has a transmittance comprised between 20% and 70%, in the range of wavelengths comprised between 380 nm and 780 nm.

35. The lens according to claim 19, further comprising a layer made of a material that also has a base tint in the deactivated state, such that the lens has a first tint, when the photochromatic layer is in the activated state, and a second tint, different from the first tint, when the photochromatic layer is in the deactivated state.

36. The lens according to claim 19, further comprising a layer that has a first substance, which has UV400 filter properties, and a second substance, which has photochromatic properties, mixed together.
